(19) United States
(12) Patent Application Publication
(10) Pub. No.: US 2015/0077269 A1
(43) Pub. Date: Mar. 19, 2015

(54) METHOD AND TERMINAL FOR CONTROLLING LOCATION INFORMATION COLLECTION

(71) Applicant: Huawei Technologies Co., Ltd., Shenzhen (CN)

(72) Inventors: Fei Hua, Shanghai (CN); Renjing Lin, Shanghai (CN); Kuanxin Guo, Shenzhen (CN)

(21) Appl. No.: 14/553,390

(22) Filed: Nov. 25, 2014

Related U.S. Application Data
(63) Continuation of application No. PCT/CN2012/076086, filed on May 25, 2012.

(51) Int. Cl. G08C 17/02

(52) U.S. Cl. CPC G08C 17/02
USPC 340/870.16

(57) ABSTRACT

Embodiments of the present invention relate to a method and a terminal for controlling location information collection. The method includes: detecting an active/inactive status of at least one terminal location information collection operation of a terminal; detecting a connection status and/or a service status of the terminal; and stopping all active terminal location information collection operations if the connection status and/or the service status of the terminal meets a first preset condition; or, starting at least one inactive terminal location information collection operation if the connection status and/or the service status of the terminal meets a second preset condition. The embodiments of the present invention save electrical energy of the terminal.

### CROSS-REFERENCE TO RELATED APPLICATIONS

This application is a continuation of International Application No. PCT/CN2012/076086, filed on May 25, 2012, which is hereby incorporated by reference in its entirety.

### TECHNICAL FIELD

Embodiments of the present invention relate to the field of communications technologies, and in particular, to a method and a terminal for controlling location information collection.

### BACKGROUND

A location-based service (Location Based Service, LBS) is a common application in a mobile communication network. An application of an LBS type may be installed on a terminal to collect terminal location information, including such geographic information as longitude and latitude of the terminal, and the like. A network side may analyze a network status at each location according to the terminal location information and various measurement information reported by the terminal, to implement network optimization.

In the prior art, once the application that is installed on the terminal and needs to collect location information is started, a location information collecting module that implements a function of collecting location information is started synchronously and is not disabled until the terminal exits the application. The constantly active status of the location information collecting module leads to great consumption of electricity of the terminal.

### SUMMARY

Embodiments of the present invention provide a method and a terminal for controlling location information collection to save electrical energy of the terminal.

In one aspect, an embodiment of the present invention provides a method for controlling location information collection, including:

detecting an active/inactive status of at least one terminal location information collection operation of a terminal;

detecting a connection status and/or a service status of the terminal; and

stopping all active terminal location information collection operations if the connection status and/or the service status of the terminal meets a first preset condition; or, starting at least one inactive terminal location information collection operation if the connection status and/or the service status of the terminal meets a second preset condition.

In another aspect, an embodiment of the present invention further provides a terminal, including:

at least one collecting module, a detecting module, and a controlling module; where

each collecting module is configured to perform a terminal location information collection operation;

the detecting module is configured to detect an active/inactive status of a terminal location information collection operation performed by each collecting module, and detect a connection status and/or a service status of the terminal; and

the controlling module is configured to: if the connection status and/or the service status of the terminal meets a first preset condition, disable all active collecting modules to stop the terminal location information collection operations performed by the collecting modules; or, if the connection status and/or the service status of the terminal meets a second preset condition, enable at least one inactive collecting module to make the collecting module perform the terminal location information collection operation.

With the method and the terminal for controlling location information collection in the embodiments of the present invention, through detection of a connection status and/or a service status of a terminal, active terminal location information collection operations are stopped or an inactive terminal location information collection operation is started when a preset condition is met, thereby saving electrical energy of the terminal and improving flexibility of collecting terminal location information.

### BRIEF DESCRIPTION OF THE DRAWINGS

To describe the technical solutions in the embodiments of the present invention more clearly, the following briefly introduces the accompanying drawings required for describing the embodiments. Apparently, the accompanying drawings in the following descriptions show merely some embodiments of the present invention, and persons of ordinary skill in the art may still derive other drawings from the accompanying drawings without creative efforts.

FIG. 1 is a flowchart of an embodiment of a method for controlling location information collection according to the present invention;

FIGS. 2A and 2B are a flowchart of another embodiment of the method for controlling location information collection according to the present invention;

FIG. 3 is a schematic structural diagram of an embodiment of a terminal according to the present invention; and

FIG. 4 is a schematic structural diagram of another embodiment of the terminal according to the present invention.

### DETAILED DESCRIPTION

The following clearly describes the technical solutions in the embodiments of the present invention with reference to the accompanying drawings in the embodiments of the present invention. Apparently, the described embodiments are merely a part rather than all of the embodiments of the present invention. All other embodiments obtained by persons of ordinary skill in the art based on the embodiment of the present invention without creative efforts shall fall within the protection scope of the present invention.

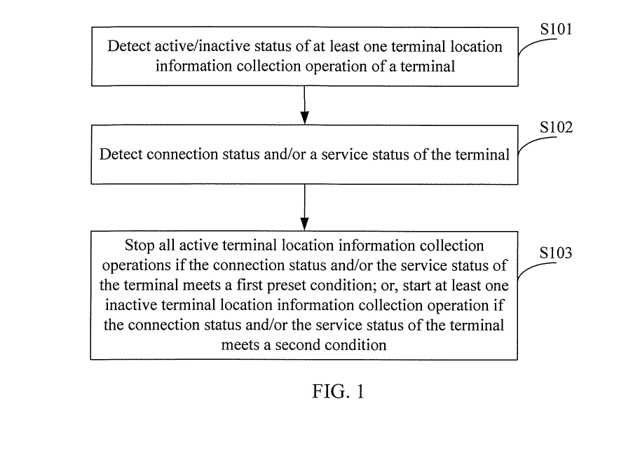

FIG. 1 is a flowchart of an embodiment of a method for controlling location information collection according to the present invention. As shown in FIG. 1, the method includes the following steps:

S101. Detect an active/inactive status of at least one terminal location information collection operation of a terminal.

S102. Detect a connection status and/or a service status of the terminal.

S103. Stop all active terminal location information collection operations if the connection status and/or the service status of the terminal meets a first preset condition; or, start at least one inactive terminal location information collection operation if the connection status and/or the service status of the terminal meets a second preset condition.

The execution subject for performing the above steps is a terminal, and may be one of various mobile terminals, PADS, or various other terminals capable of detecting location information.

The terminal mentioned in the embodiment of the present invention is capable of performing at least one terminal location information collection operation, and the collected terminal location information may be, for example, longitude information and latitude information. The operation modes of terminal location information collection supported by the terminal may include one or more of the following types: (1) A global positioning system (Global Positioning System, GPS) module is set on the terminal, and the location information of the terminal is collected by using the GPS module directly; (2) the terminal sends its cell and adjacent cell measurement information to a network server so that the network server obtains the terminal location information from a specific database according to the cell and adjacent cell measurement information reported by the terminal; and (3) the terminal sends wireless fidelity (Wireless fidelity, WIFI) network measurement information to the network server so that the network server obtains the terminal location information from a specific database according to the WIFI network measurement information sent by the terminal. It should be noted that the above examples are only several feasible modes regarding how a terminal performs a location information collection operation, and shall not be construed as a limitation on the embodiments of the present invention. The operation modes of terminal location information collection mentioned in the embodiment of the present invention may also be various existing location information collection operation modes.

After the terminal obtains the location information, the network side may analyze a network status in each location according to the terminal location information and various measurement information reported by the terminal, and perform network optimization, or perform other operations, which are not described here exhaustively.

When the terminal needs to collect location information, the terminal may perform any location information collection operation supported by the terminal. If the terminal supports multiple location information collection operation modes, the terminal may also perform any two or more location information collection operations simultaneously. Further, when one location information collection operation fails to collect the terminal location information, at least one remaining location information collection operation may be started.

The terminal may detect the active/inactive status of at least one terminal location information collection operation of the terminal, that is, detect whether a terminal location information collection operation is underway. Besides, the terminal may also detect the connection status and/or the service status of the terminal, and stop all active terminal location information collection operations if the connection status and/or the service status of the terminal is detected as meeting a first preset condition; or, start at least one inactive terminal location information collection operation if the connection status and/or the service status of the terminal is detected as meeting a second preset condition. S101 and S102 may be performed without a specific order. To be specific, S101 may be performed before S102, or S102 may be performed before S101, or S101 and S102 may be performed simultaneously.

Specifically, the connection status of the terminal may refer to a status of a connection between the terminal and the network side, signal quality of the terminal, and so on; the service status of the terminal may refer to whether a voice service, a data service, and the like, is underway on the terminal.

The terminal may preset the first preset condition according to actual requirements, and, if the terminal meets the first preset condition, all active terminal location information collection operations are stopped when at least one terminal location information collection operation of the terminal is detected as underway.

As a feasible implementation mode, the first preset condition to be met by the connection status and/or the service status of the terminal may include any one of or any combination of the following: no terminal location information is collected within a first preset time threshold, a voice service of the terminal is complete, a data service of the terminal is complete, start time of the terminal location information collection operation exceeds a second preset time threshold, and the like.

Optionally, if no terminal location information is collected within the first preset time threshold, all active location information collection operations for the terminal may be stopped. Specifically:

Because specific processes of location information collection operations of the terminal are different, the time of obtaining the terminal location information in each location information collection operation may be different. Therefore, for each location information collection operation of the terminal, a time threshold may be set respectively (for example, a first preset time threshold is set, which may be set as specifically required by the terminal; the first preset time threshold may be different or be the same between all the location information collection operations). The specific time threshold may be implemented by a timer that sets a timing period. For example, for a terminal location information collection operation performed by a GPS module, the first preset time threshold may be A; for an operation of sending the terminal's cell and adjacent cell measurement information to a network server to obtain terminal location information, the first preset time threshold may be B; for an operation of sending WIFI network measurement information to the network server to obtain terminal location information, the first preset time threshold may be C. If any one and only one of location information collection operation described above is underway on the terminal, the location information collection operation may be stopped if no terminal location information is obtained when the location information collection operation exceeds the corresponding first preset time threshold. If any two or more than location information collection operations described above are underway on the terminal, the two or more location information collection operations may be stopped if no terminal location information is obtained when all the two or more location information collection operations exceed their respective first preset time thresholds.

Optionally, if a voice service of the terminal is complete, all active terminal location information collection operations may be stopped; if a data service of the terminal is complete, all active terminal location information collection operations may be stopped. Specifically:

If only a voice service is currently active on the terminal, when the voice service of the terminal is detected as inactive, for example, it is detected that the user completes a call, or a call link release process is started between the terminal and a serving cell, or the status of an external interface of an operating system of the terminal changes, or characteristic data packet output of a terminal chip changes, or the like, closing all terminal location information collection operations may be triggered (where the closing may be performed immediately or delayed). If only a data service is currently active on the terminal, when the data service of the terminal is detected as inactive, for example, it is detected that the user exits a webpage browser and stops accessing the Internet, or a data service link release process is started between the terminal and a serving cell, or the status of an external interface of an operating system of the terminal changes, or characteristic data packet output of a terminal chip changes, or the like, closing all terminal location information collection operations may be triggered (where the closing may be performed immediately or delayed). If both a voice service and a data service are currently active on the terminal, and it is detected that one of the services of the terminal stops but the other service goes on, closing all terminal location information collection operations may be triggered when the other service of the terminal is also detected as inactive.

Optionally, if start time of the terminal location information collection operation exceeds a second preset time threshold, all active terminal location information collection operations may be stopped. Specifically:

Further, for each location information collection operation, a start threshold may be set (a second preset time threshold, which may be set as specifically required by the terminal; the second preset time threshold may vary or be the same between all the location information collection operations). When any one and only one of location information collection operation is underway on the terminal, the location information collection operation may be stopped when it is detected that the duration of the location information collection operation exceeds the second preset time threshold. If any two or more location information collection operations are underway on the terminal, when the duration of any one of the location information collection operations exceeds the second preset time threshold corresponding to this location information collection operation, this location information collection operation may be stopped.

Likewise, the terminal may preset a second preset condition according to actual requirements. When the terminal location information collection operation is detected as inactive, if the connection status and/or the service status of the terminal meets the second preset condition, at least one inactive terminal location information collection operation is started.

As a feasible implementation mode, the second preset condition to be met by the connection status and/or the service status of the terminal may include any one of or any combination of the following: a serving cell or a residing cell of the terminal changes, the terminal is detached from network coverage, signal strength in coverage of the terminal is lower than a first preset threshold, a voice service of the terminal is activated, a data service of the terminal is activated, and interference on signals in coverage of the terminal exceeds a second preset threshold.

Optionally, if a serving cell or a residing cell of the terminal changes, at least one inactive terminal location information collection operation may be started. Specifically, when the terminal detects that the information on a cell in communication with the terminal changes, for example, the serving cell or the residing cell of the terminal changes, the terminal may be located at a border of the cell because of movement. In this case, the collected terminal location information is used in combination with the current signal quality of the terminal, the user experience satisfaction degree, and other measurement values so that the network server can better analyze weakly covered areas of the current network, which is good for network optimization. Therefore, in such an implementation scenario, at least one inactive terminal location information collection operation may be started.

Optionally, if a voice service of the terminal is activated and/or a data service of the terminal is activated, at least one inactive terminal location information collection operation may be started. Specifically:

When the voice service of the terminal is detected as active, for example, it is detected that the user inputs a telephone number and then presses a dial key, or a call setup process is started between the terminal and a serving cell, or the status of an external interface of an operating system of the terminal changes, or characteristic data packet output of a terminal chip changes, or the like, at least one inactive terminal location information collection operation may be started. When the data service of the terminal is detected as active, for example, it is detected that the user opens a webpage browser and jumps to a web address, or a data service setup process is started between the terminal and a serving cell, or the status of an external interface of an operating system of the terminal changes, or characteristic data packet output of a terminal chip changes, or the like, at least one inactive terminal location information collection operation may be started.

Optionally, if the terminal is detached from network coverage or signal strength in coverage of the terminal is lower than a first preset threshold, at least one inactive terminal location information collection operation may be started. Specifically:

It is detected that the terminal is detached from the network or that the signal strength in coverage of the terminal is weak and lower than a first preset threshold (where the first preset threshold may be a signal strength threshold and may be set as specifically required by the terminal), for example, a mobile communication network has a coverage cavity due to severe obstruction of buildings, and the terminal loses contact with the network when the user travels to the coverage cavity. In this case, the status of an external interface of an operating system of the terminal changes, or characteristic data packet information of a terminal chip changes, and therefore, at least one inactive terminal location information collection operation may be started. For another example, spacing between base stations is too great, which leads to weak signals at the boundary of the base station coverage. When the user travels to a weakly covered area (with signal strength being lower than a first preset threshold, where the first preset threshold may be set as specifically required), a measurement report may be transmitted between the terminal and the serving cell, or the status of an external interface of an operating system of the terminal changes, or data packet information of a terminal chip changes, or the like, and therefore, at least one inactive terminal location information collection operation may be started.

Optionally, if interference on signals in coverage of the terminal exceeds a second preset threshold, at least one inactive terminal location information collection operation may be started. Specifically:

If the terminal detects that the interference on the signals in coverage of the terminal exceeds a second preset threshold (where the second preset threshold may be a signal quality threshold such as a ratio of the signal strength to the signal interference strength, which may be set as specifically required by the terminal), for example, multiple cells overlay an area so that the signal-to-interference ratio of the area exceeds a second preset threshold and that the terminal signal suffers severe interference. When the user travels to this pilot pollution area, the status of an external interface of an operating system of the terminal changes, or data packet information of a terminal chip changes, or the like, and therefore, at least one inactive terminal location information collection operation may be started.

It should be noted that both the first preset condition and the second preset condition may be set according to specific requirements of the terminal and electricity consumption of the terminal in various circumstances. All active terminal location information collection operations are stopped if the connection status and/or the service status of the terminal meets the first preset condition; at least one location information collection operation is started if the connection status and/or the service status of the terminal meets the second preset condition. The terminal may start any one of the location information collection operations, or may start any two or more location information collection operations; or, if no terminal location information is obtained when a duration of any one of the active location information collection operations exceeds a specific period, any one of the remaining location information collection operations may be started.

With the method for controlling location information collection in the embodiment of the present invention, through detection of a connection status and/or a service status of a terminal, active terminal location information collection operations are stopped or an inactive terminal location information collection operation is started when a preset condition is met, thereby saving electrical energy of the terminal and improving flexibility of collecting terminal location information.

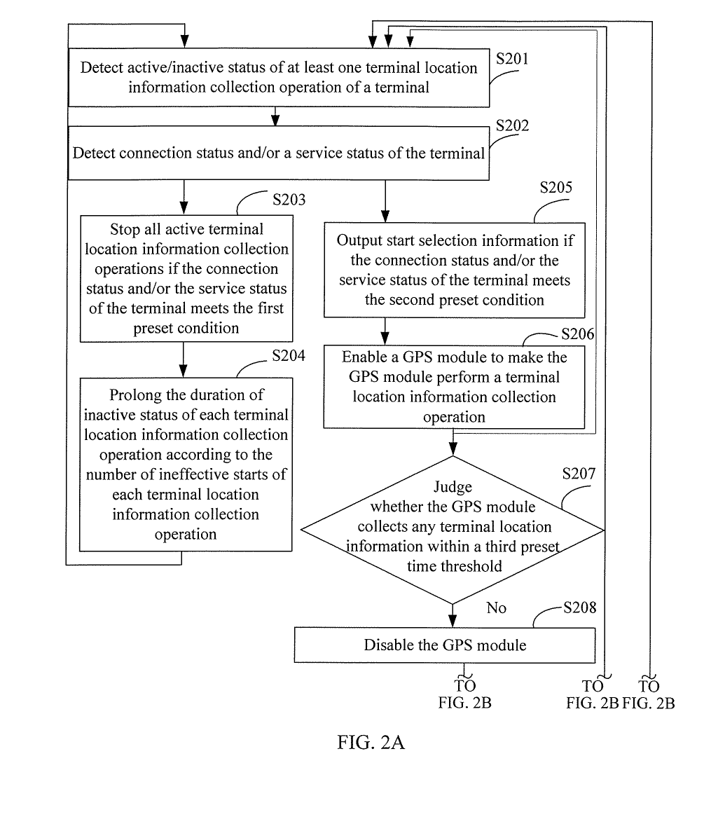

FIG. 2 is a flowchart of another embodiment of the method for controlling location information collection according to the present invention. As shown in FIG. 2, the method includes the following steps:

S201. Detect an active/inactive status of at least one terminal location information collection operation of the terminal. If at least one terminal location information collection operation of the terminal is active, perform S202 to S204; if all terminal location information collection operations are inactive, perform S205 to S212.

S202. Detect a connection status and/or a service status of the terminal.

S201 and S202 may be performed without a specific order. To be specific, S201 may be performed before S202, or S202 may be performed before S201, or S201 and S202 may be performed simultaneously.

S203. Stop all active terminal location information collection operations if the connection status and/or the service status of the terminal meets the first preset condition.

For the detection of the connection status and/or the service status of the terminal and the feasible implementation mode of the first preset condition, reference may be made to the relevant description in the previous embodiment, and no repeated description is given here any further.

S204. Prolong the duration of the inactive status of each terminal location information collection operation according to the number of ineffective starts of the terminal location information collection operation, where one ineffective start of any terminal location information collection operation refers to one occasion of collecting no terminal location information in a process from start to stop of the terminal location information collection operation.

Specifically, if the connection status and/or the service status of the terminal meets the second preset condition, at least one location information collection operation of the terminal is started, and the terminal starts to perform the operation of collecting location information. If the location information collection operation is closed when the connection status and/or the service status of the terminal meets the first preset condition, the terminal possibly collects no terminal location information in the process from start to closing of the location information collection operation, while the electricity of the terminal is wasted. To further prevent ineffective start, the terminal may prolong the duration of the inactive status of the terminal location information collection operation according to the number of ineffective starts of each terminal location information collection operation.

Specifically, a counter is set on the terminal for each terminal location information collection operation. The initial value of the counter is set to 0, and the initial value of a “penalty time” is set to 0. Taking any location information collection operation as an example, if no terminal location information is obtained in the process from start to stop of the location information collection operation, the counter corresponding to the location information collection operation increases the count of ineffective starts by 1. In this way, with increase of the ineffective starts, the counter accumulates the number of ineffective starts. For one ineffective start, the terminal may prolong the time to stop when the location information collection operation ends, that is, give a certain “penalty time” of stopping the location information collection operation to the location information collection operation. With more ineffective starts, the time to stop of the location information collection operation may be longer. Different corresponding proportions of the number of ineffective starts to the penalty time may be set, and no start of the location information collection operation is allowed within the penalty time, thereby reducing possibility of ineffective starts and avoiding futile electricity consumption of the terminal.

It should be noted that S201 and S202 may be performed in real time, that is, after all terminal location information collection operations in S204 are stopped, the terminal may further perform S201 and S202.

S205. Output start selection information if the connection status and/or the service status of the terminal meets a second preset condition, where the start selection information is used to instruct the user to determine whether to start at least one inactive terminal location information collection operation.

If the connection status and/or the service status of the terminal meets the second preset condition, the terminal may display an “event-triggered location mode selection interface” to the user, and, through the interface, output start selection information to the user and instruct the user to determine whether to start at least one inactive terminal location information collection operation.

If the user selects “start at least one inactive terminal location information collection operation”, the terminal may directly start at least one inactive terminal location information collection operation. If the user selects “refuse to start at least one inactive terminal location information collection operation”, the process ends.

Further, the terminal may provide start modes available for being selected by the user. The user may select a trigger start mode that enables the terminal's automatic start—“start at least one inactive terminal location information collection operation if the connection status and/or the service status of the terminal meets the second preset condition”; and the user may select to confirm a trigger condition of triggering start of at least one inactive terminal location information collection operation. Besides, the terminal may configure one or more types of the second preset condition by default, and the configuration may be based on the operating system supported by each different terminal, terminal model, manufacturer, terminal capabilities, and the like.

It is assumed that the terminal supports the following three terminal location information collection operations: (1) a terminal location information collection operation performed by a GPS module; (2) an operation of sending the terminal's cell and adjacent cell measurement information to a network server to obtain the terminal location information; and (3) an operation of sending wireless fidelity WIFI network measurement information to the network server to obtain the terminal location information. If the three terminal location information collection operations (1) to (3) are ranked in a descending order of priority, the process of the terminal starting or stopping the location information collection operation may be: when the terminal detects the location information collection operation as closed, the terminal may use the GPS module to directly collect terminal location information first so long as the connection status and/or the service status of the terminal is detected as meeting the second preset condition; if the GPS module fails to collect the terminal location information within a third preset time threshold, the terminal may disable the GPS module to stop the collection of the terminal location information, and then the terminal may send the terminal's cell and adjacent cell measurement information to a network server to obtain the terminal location information; if no terminal location information is obtained within a fourth preset time threshold, the terminal may further send WIFI network measurement information to the network server to obtain the terminal location information; if no terminal location information is obtained within a fifth preset time threshold, the terminal stops sending the WIFI network measurement information to the network server.

The following uses a more detailed example to describe a process of starting or stopping a terminal location information collection operation.

S206. Enable a GPS module to make the GPS module perform a terminal location information collection operation.

S207. Determine whether the GPS module collects any terminal location information within a third preset time threshold; if yes, the GPS module continues performing the terminal location information collection operation; if no, perform S208.

S208. Disable the GPS module to make the GPS module stop performing the terminal location information collection operation.

S209. Send the terminal's cell and adjacent cell measurement information to a network server to obtain the terminal location information.

S210. Determine whether the terminal location information is obtained within a fourth preset time threshold; if yes, perform S209; if no, perform S211.

S211. Stop sending the terminal's cell and adjacent cell measurement information to the network server.

S212. Send WIFI network measurement information to the network server to obtain the terminal location information.

S213. Determine whether the terminal location information is obtained within a fifth preset time threshold; if yes, perform S212; if no, perform S214.

S214. Stop sending the WIFI network measurement information to the network server.

Given above are only examples. In practical application, the terminal may set different priority levels for the various location information collection operations described above, and start the various terminal location information collection operations in a descending order of priority. It should be noted that S201 and S202 may be performed in real time, that is, after the terminal location information collection operations in S206 or S209 or S212 are started, the terminal may further perform S201 and S202.

After the terminal obtains the location information, the network side may analyze a network status in each location according to the terminal location information and various measurement information reported by the terminal, and perform network optimization, or perform other operations.

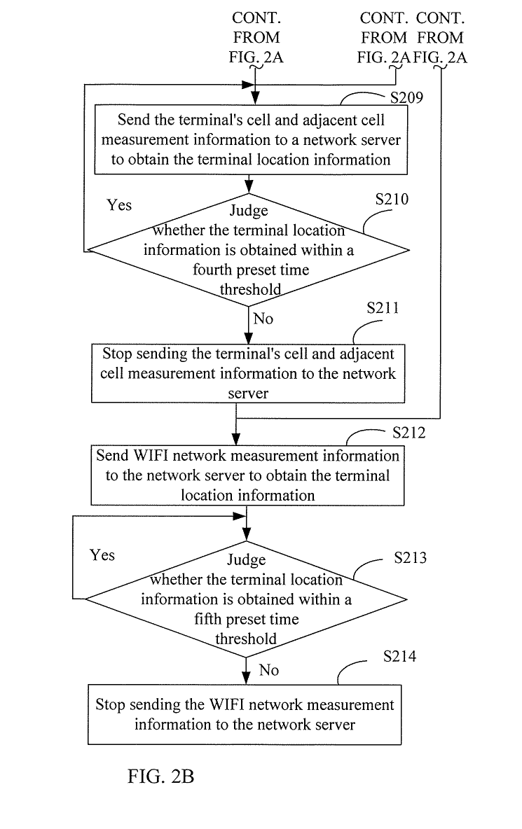

FIG. 3 is a schematic structural diagram of an embodiment of a terminal according to the present invention. As shown in FIG. 3, the terminal includes at least one collecting module 11, a detecting module 12, and a controlling module 13; where

each collecting module 11 is configured to perform a terminal location information collection operation;

the detecting module 12 is configured to detect an active/inactive status of a terminal location information collection operation performed by each collecting module 11, and detect a connection status and/or a service status of the terminal; and

the controlling module 13 is configured to: if the connection status and/or the service status of the terminal detected by the detecting module 12 meets a first preset condition, disable all active collecting modules 11 to stop the terminal location information collection operations performed by the collecting modules 11; or, if the connection status and/or the service status of the terminal meets a second preset condition, enable at least one inactive collecting module 11 to make the collecting module 11 perform the terminal location information collection operation.

Optionally, the first preset condition to be met by the connection status and/or the service status of the terminal includes any one of or any combination of the following: no terminal location information is collected by any active collecting module 11 within a first preset time threshold, a voice service of the terminal is complete, a data service of the terminal is complete, and start time of at least one collecting module 11 exceeds a second preset time threshold.

Optionally, the second preset condition to be met by the connection status and/or the service status of the terminal includes any one of or any combination of the following: a serving cell or a residing cell of the terminal changes, the terminal is detached from network coverage, signal strength in network coverage of the terminal is lower than a first preset threshold, a voice service of the terminal is activated, a data service of the terminal is activated, and interference on signals in coverage of the terminal exceeds a second preset threshold.

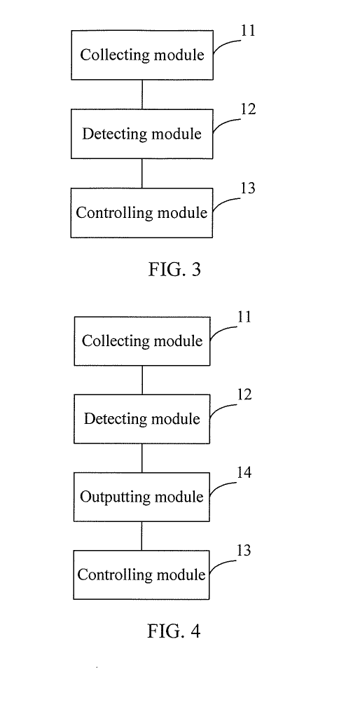

FIG. 4 is a schematic structural diagram of another embodiment of the terminal according to the present invention. As shown in FIG. 4, the terminal may further include:

an outputting module 14, configured to output start selection information, where the start selection information is used to instruct a user to determine whether to enable at least one inactive collecting module 11.

Optionally, the at least one collecting module 11 includes any one of or any combination of the following: a global positioning system GPS module, a first collecting module configured to send the terminal's cell and adjacent cell measurement information to a network server to obtain terminal location information, and a second collecting module configured to send wireless fidelity WIFI network measurement information to the network server to obtain the terminal location information.

Optionally, the controlling module 13 may be specifically configured to: if the connection status and/or the service status of the terminal meets a second preset condition, enable the GPS module to make the GPS module perform the terminal location information collection operation.

Further, the controlling module 13 may be further configured to: if the GPS module collects no terminal location information within a third preset time threshold, disable the GPS module to make the GPS module stop performing the terminal location information collection operation.

Optionally, the controlling module 13 may be further specifically configured to: if the connection status and/or the service status of the terminal meets the second preset condition, enable the first collecting module to make the first collecting module send the terminal's cell and adjacent cell measurement information to the network server.

Further, the controlling module 13 may be further configured to: if the first collecting module collects no terminal location information within a fourth preset time threshold, disable the first collecting module to make the first collecting module stop sending the terminal's cell and adjacent cell measurement information to the network server.

Optionally, the controlling module 13 may be further specifically configured to: if the connection status and/or the service status of the terminal meets the second preset condition, enable the second collecting module to make the second collecting module send WIFI network measurement information to the network server.

Further, the controlling module 13 may be further configured to: if no terminal location information is obtained within a fifth preset time threshold, disable the second collecting module to make the second collecting module stop sending the WIFI network measurement information to the network server.

Optionally, the controlling module 13 may be further configured to prolong a duration of the inactive status of each collecting module 11 according to the number of ineffective starts of each collecting module 11, where one ineffective start of any collecting module 11 refers to one occasion of collecting no terminal location information in a process from start to stop of the collecting module 11.

The terminal provided in the embodiment of the present invention is a device for performing the method for controlling location information collection that is provided in the embodiment of the present invention. For its process of performing the method for controlling location information collection, reference may be made to the embodiments of the method for controlling location information collection that is provided herein, and no repeated description is given here any further.

With the terminal provided in the embodiment of the present invention, through detection of a connection status and/or a service status of a terminal, active terminal location information collection operations are stopped or an inactive terminal location information collection operation is started when a preset condition is met, thereby saving electrical energy of the terminal and improving flexibility of collecting terminal location information.

Persons of ordinary skill in the art may understand that all or part of the steps in each of the foregoing method embodiments may be implemented by a program instructing relevant hardware. The program may be stored in a computer readable storage medium. When the program is run, the steps of the forgoing methods in the embodiments are performed. The storage medium includes any medium that is capable of storing program codes, such as a ROM, a RAM, a magnetic disk, or an optical disk.

Finally, it should be noted that the foregoing embodiments are merely intended for describing the technical solutions of the present invention rather than limiting the present invention. Although the present invention is described in detail with reference to the foregoing embodiments, persons of ordinary skill in the art should understand that they may still make modifications to the technical solution described in the foregoing embodiments or make equivalent replacements to some technical features thereof; without departing from the spirit and scope of the technical solution of the embodiments of the present invention.

What is claimed is:

1. A method for controlling location information collection, the method comprising:
detecting an active/inactive status of at least one terminal location information collection operation of a terminal;
detecting a connection status and/or a service status of the terminal; and
stopping all active terminal location information collection operations if the connection status and/or the service status of the terminal meets a first preset condition; or, starting at least one inactive terminal location information collection operation if the connection status and/or the service status of the terminal meets a second preset condition.

2. The method according to claim 1, wherein the first preset condition to be met by the connection status and/or the service status of the terminal comprises any one of or any combination of the following: no terminal location information is collected within a first preset time threshold, a voice service of the terminal is complete, a data service of the terminal is complete, and start time of the at least one terminal location information collection operation exceeds a second preset time threshold.

3. The method according to claim 1, wherein the second preset condition to be met by the connection status and/or the service status of the terminal comprises any one of or any combination of the following: a serving cell or a residing cell of the terminal changes, the terminal is detached from network coverage, signal strength in network coverage of the terminal is lower than a first preset threshold, a voice service of the terminal is activated, a data service of the terminal is activated, and interference on signals in coverage of the terminal exceeds a second preset threshold.

4. The method according to claim 1, wherein before starting at least one inactive terminal location information collection operation, the method further comprises:
outputting start selection information, wherein the start selection information is used to instruct a user to determine whether to start at least one inactive terminal location information collection operation.

5. The method according to claim 1, wherein the at least one location information collection operation comprises any one of or any combination of the following: a terminal location information collection operation performed by a global positioning system (GPS) module of the terminal, an operation of sending the terminal's cell and adjacent cell measurement information to a network server to obtain terminal location information, and an operation of sending wireless fidelity (WIFI) network measurement information to the network server to obtain the terminal location information.

6. The method according to claim 5, wherein starting at least one inactive terminal location information collection operation comprises:
enabling the GPS module to make the GPS module perform a terminal location information collection operation.

7. The method according to claim 6, wherein after starting at least one inactive terminal location information collection operation, the method further comprises:
disabling the GPS module to make the GPS module stop performing the terminal location information collection operation if the GPS module collects no terminal location information within a third preset time threshold.

8. The method according to claim 5, wherein starting at least one inactive terminal location information collection operation comprises:
sending the terminal's cell and adjacent cell measurement information to the network server to obtain the terminal location information.

9. The method according to claim 8, wherein after starting at least one inactive terminal location information collection operation, the method further comprises:
stopping sending the terminal's cell and adjacent cell measurement information to the network server if no terminal location information is obtained within a fourth preset time threshold.

10. The method according to claim 5, wherein starting at least one inactive terminal location information collection operation comprises:
sending WIFI network measurement information to the network server to obtain the terminal location information.

11. The method according to claim 10, wherein after starting at least one inactive terminal location information collection operation, the method further comprises:
stopping sending the WIFI network measurement information to the network server if no terminal location information is obtained within a fifth preset time threshold.

12. The method according to claim 1, wherein after stopping all active terminal location information collection operations, the method further comprises:
prolonging a duration of the inactive status of each terminal location information collection operation according to the number of ineffective starts of the terminal location information collection operation, wherein one ineffective start of any terminal location information collection operation refers to one occasion of collecting no terminal location information in a process from start to stop of the terminal location information collection operation.

13. A terminal, comprising at least one collecting module, a detecting module, and a controlling module, wherein:
each collecting module is configured to perform a terminal location information collection operation;
the detecting module is configured to detect an active/inactive status of the terminal location information collection operation performed by each collecting module, and further detect a connection status and/or a service status of the terminal; and
the controlling module is configured to:
if the connection status and/or the service status of the terminal detected by the detecting module meets a first preset condition, disable all active collecting modules to stop the terminal location information collection operations performed by the collecting modules, or
if the connection status and/or the service status of the terminal meets a second preset condition, enable at least one inactive collecting module to make the collecting module perform the terminal location information collection operation.

14. The terminal according to claim 13, wherein the first preset condition to be met by the connection status and/or the service status of the terminal comprises any one of or any combination of the following: no terminal location information is collected by any active collecting module within a first preset time threshold, a voice service of the terminal is complete, a data service of the terminal is complete, and start time of the at least one collecting module exceeds a second preset time threshold.

15. The terminal according to claim 13, wherein the second preset condition to be met by the connection status and/or the service status of the terminal comprises any one of or any combination of the following: a serving cell or a residing cell of the terminal changes, the terminal is detached from network coverage, signal strength in network coverage of the terminal is lower than a first preset threshold, a voice service of the terminal is activated, a data service of the terminal is activated, and interference on signals in coverage of the terminal exceeds a second preset threshold.

16. The terminal according to claim 13, further comprising:
an outputting module, configured to output start selection information, wherein the start selection information is used to instruct a user to determine whether to enable at least one inactive collecting module.

17. The terminal according to claim 13, wherein the at least one collecting module comprises any one of or any combination of the following: a global positioning system (GPS) module, a first collecting module configured to send the terminal's cell and adjacent cell measurement information to a network server to obtain terminal location information, and a second collecting module configured to send wireless fidelity WIFI network measurement information to the network server to obtain the terminal location information.

18. The terminal according to claim 17, wherein the controlling module is configured to:
if the connection status and/or the service status of the terminal meets a second preset condition, enable the GPS module to make the GPS module perform the terminal location information collection operation.

19. The terminal according to claim 18, wherein the controlling module is further configured to:
if the GPS module collects no terminal location information within a third preset time threshold, disable the GPS module to make the GPS module stop performing the terminal location information collection operation.

20. The terminal according to claim 17, wherein the controlling module is configured to:
if the connection status and/or the service status of the terminal meets the second preset condition, enable the first collecting module to make the first collecting module send the terminal's cell and adjacent cell measurement information to the network server.

21. The terminal according to claim 20, wherein the controlling module is further configured to:
if the first collecting module collects no terminal location information within a fourth preset time threshold, disable the first collecting module to make the first collecting module stop sending the terminal's cell and adjacent cell measurement information to the network server.

22. The terminal according to claim 17, wherein the controlling module is configured to:
if the connection status and/or the service status of the terminal meets the second preset condition, enable the second collecting module to make the second collecting module send WIFI network measurement information to the network server.

23. The terminal according to claim 22, wherein the controlling module is further configured to:
if no terminal location information is obtained within a fifth preset time threshold, disable the second collecting module to make the second collecting module stop sending the WIFI network measurement information to the network server.

24. The terminal according to claim 13, wherein the controlling module is further configured to:
prolong a duration of the inactive status of each collecting module according to the number of ineffective starts of each collecting module, wherein one ineffective start of any one of the collecting modules refers to one occasion of collecting no terminal location information in a process from start to stop of the collecting module.
